(19) United States
(12) Patent Application Publication
(10) Pub. No.: US 2025/0021891 A1
(43) Pub. Date: Jan. 16, 2025

(54) MACHINE LEARNING MODEL ALIGNMENT

(71) Applicants: Beijing Youzhuju Network Technology Co., Ltd., Beijing (CN); Lemon Inc., Grand Cayman (KY)

(72) Inventors: Yuanshun Yao, Los Angeles, CA (US); Hongyi Guo, Los Angeles, CA (US); Xiaoying Zhang, Beijing (CN); Yang Liu, Los Angeles, CA (US)

(21) Appl. No.: 18/900,432

(22) Filed: Sep. 27, 2024

(51) Int. Cl. G06N 20/00

(52) U.S. Cl. CPC G06N 20/00

(57) ABSTRACT

A method is proposed for machine learning (ML) model alignment. In the method, a first number of samples is generated by a target ML model based on samples selected from a set of samples. A sample comprises a question-answer pair. The set of samples is updated by adding at least a portion of the first number of samples to the set of samples. The target ML model is trained with at least a portion of the updated set of samples. In this way, the ML model self-generalization ability is unlocked to perform alignment with near-zero human supervision.

### FIELD

The present disclosure generally relates to tensor processing, and more specifically, to methods, devices, and computer program products for machine learning (ML) model alignment.

### BACKGROUND

The burst of language models (LMs) has brought various exciting applications to the world. The technique to make LMs follow human instructions and generate safe outputs is alignment. As LMs continue to be explored and developed, it is necessary to ensure their correct alignment and ethical use to maximize their advantages and minimize potential hazards.

### SUMMARY

In a first aspect of the present disclosure, there is provided a method of ML model alignment. The method includes generating a first number of samples by a target ML model based on samples selected from a set of samples, a sample including a question-answer pair; updating the set of samples by adding at least a portion of the first number of samples to the set of samples; and training the target ML model with at least a portion of the updated set of samples.

In a second aspect of the present disclosure, there is provided an electronic device. The electronic device includes: a computer processor coupled to a computer-readable memory unit, the memory unit including instructions that when executed by the computer processor implements a method according to the first aspect of the present disclosure.

In a third aspect of the present disclosure, there is provided a computer program product, the computer program product including a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the more detailed description of some embodiments of the present disclosure in the accompanying drawings, the above and other objects, features, and advantages of the present disclosure will become more apparent, wherein the same reference generally refers to the same components in some embodiments of the present disclosure.

FIG. 1 illustrates an example environment in which example embodiments of the present disclosure can be implemented;

FIG. 2 illustrates a schematic diagram of an example architecture for ML model alignment according to some embodiments of the present disclosure;

FIG. 3 illustrates a schematic diagram of an example architecture for ML model alignment according to some embodiments of the present disclosure;

FIG. 4 illustrates an example flowchart of a method of ML model alignment according to some embodiments of the present disclosure; and

FIG. 5 illustrates a block diagram of an electronic device in which various embodiments of the present disclosure can be implemented.

### DETAILED DESCRIPTION

The principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to limit example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementations of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

As used herein, the term “kernel” refers to machine executable codes which when executed perform one or more operations. For example, a central processing unit (CPU) may launch a kernel to a graphic processing unit (GPU).

As used herein, the term “model” is referred to as an association between an input and an output learned from training data, and thus a corresponding output may be generated for a given input after the training. The generation of the model may be based on a machine learning technique. In general, a machine learning model may be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

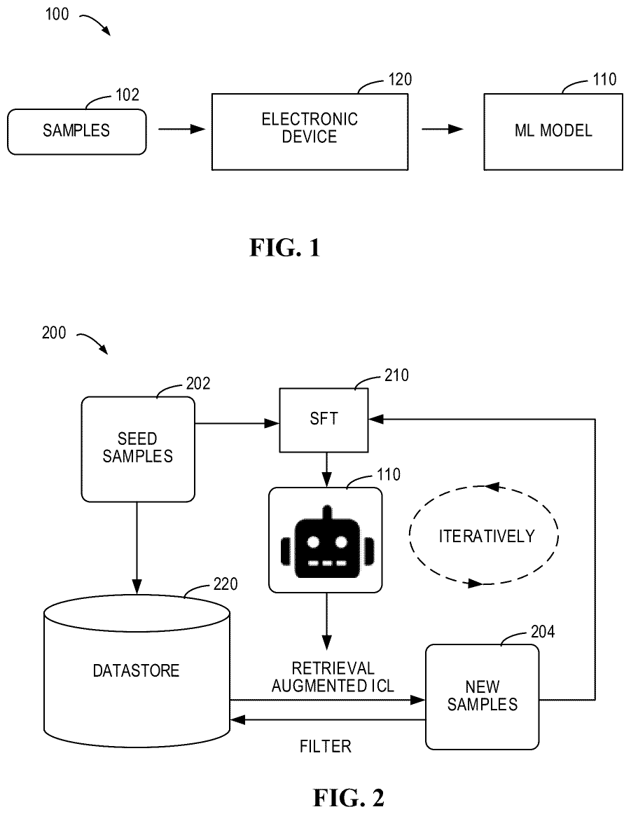

FIG. 1 illustrates a block diagram of an example environment 100 in which various embodiments of the present disclosure may be implemented. In the environment 100 of FIG. 1, an electronic device 120 receives a set of samples 102 and trains a ML model 110 for model aligning. The ML model 110 may be configured to process a natural language input.

The set of samples 102 may include information concerning natural language. For example, each sample of the set of samples 102 may include a question-answer pair. The question-answer pair may be expressed at least partially in a natural language.

In FIG. 1, the electronic device 120 may include any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

As mentioned above, the technique to make LMs follow human instructions and generate safe outputs is alignment. Currently, it is the key to generating sophisticated text and tackling a variety of language-based tasks. The mainstream alignment approaches include instruction fine-tuning and preference learning. Instruction tuning employs a supervised fine-tuning (SFT) process, largely dependent on human annotations or data derived from LMs themselves. The key technique in preference learning is reinforcement learning from human feedback (RLHF), which iteratively refines an SFT-enhanced LLM to better align with human preferences.

In the pursuit of aligning LM with human preferences, some solutions have implemented SFT using instructions annotated by a diverse group of users. Building on this, the concept of RLHF is introduced. This approach enhances alignment by learning from human preferences via a reward model trained with human-rated outputs. In some solutions, the scalability of RLHF has been further improved, which substitutes human feedback with AI-generated feedback. Recent development demonstrates that substantial alignment improvements can be achieved using as few as 1,000 examples for SFT. This finding suggests that the bulk of knowledge in LMs is mainly acquired during pretraining, and only a limited amount of instruction tuning data is required to guide models towards producing high-quality outputs. Some solutions indicate that inference-time alignment can also attain high levels of performance. The advancements collectively highlight the evolving landscape of LM alignment strategies, emphasizing efficiency and efficacy in model training.

Both SFT and RLHF are heavily data dependent. The lack of high-quality data significantly blocks the democratization of usable and safe LLMs. A few prior works propose to solve this problem with self-alignment, i.e. making the LMs align themselves with samples generated by themselves. The common assumption is that the pretrained LMs have already learned a good amount of hidden knowledge related to the aligned behaviors and they just need to be “elicited” with samples generated by LMs themselves rather than using direct human instructions.

However, the current self-alignment techniques are not truly free of human instructions. They still involve some form of hand-crafted instructions or principles to enhance the quality of the model-generated responses. It leads to some limitations. For example, crafting effective human instruction is complex. For example, it is needed to manually design 16 generic principles and multiple specific principles for different tasks. It requires substantial domain knowledge and carries a higher level of error risk compared to a more bottom-up data-driven approach. More importantly in practice, designing and refining human instructions require considerable labor, which contradicts the scenario of limited samples where human resources are lacking. Additionally, adapting these instructions for new alignment domains often requires new guidelines, which motivates a more automatable approach.

Moreover, current self-alignment can work only on large models. Existing works often require models with a significantly large number of parameters, e.g. some solutions use a model with 175B parameters and others use a model with 65B parameters. And often the approach would be less effective for smaller models like a model with 7B parameters since they are less capable of following instructions and understanding the contents.

Existing studies in the area of training or fine-tuning LLMs with self-generated datasets, often rely on human instructions, which counteracts the objective of self-alignment to reduce human intervention. Notably, those two prominent self-alignment frameworks necessitate LLMs with at least 65B parameters, as smaller models struggle with following complex human instructions using in-context learning (ICL). A recent development in this field introduces an iterative self-alignment model that utilizes a learned reward system to filter out low-quality question-answer (QA) pairs from generated datasets, thereby avoiding the complexities of elaborate principles. Self-alignment is intrinsically linked to self-supervised learning, typically involving prompt-only datasets. One solution leverage Chain-of-Thought (CoT) prompting to generate high-quality responses for unlabeled datasets. Similarly, another solution creates a principle-adhering reward model from a synthetic dataset and further enhances the LLM through reinforcement learning. Moreover, QA datasets can be derived from existing text corpora, like web corpora, prompting LLMs to generate questions from the inherent knowledge. Methods in this field include backtranslation, self-chat, and self-QA. However, these techniques depend on handcrafted principles to improve the dataset quality and typically involve a single training iteration.

A different line of approach is to use an external reward model to filter LLM-generated answers, as opposed to applying supervising principles when generating answers. However, in scenarios where the target domain for alignment has limited samples, developing high-quality reward models is challenging and often still requires a significant amount of human labor to label rewards, which again contradicts the scenario where human resources are scarce. Additionally, external reward models often suffer from out-of-distribution (OOD) issues.

In view of the above, current alignment techniques have several limitations: (1) requiring a large amount of annotated data; (2) demanding heavy human involvement; (3) lacking a systematic mechanism to continuously improve. As such, the following question is desirable to solve: Is it possible to self-align LMs to a target domain with only a few examples and without any human-designed instructions or external reward models?

The present disclosure provides a method of ML model alignment. The method relates to leveraging retrieval-augmented ICL to generate high-quality answers using contextually relevant, retrieved samples. Specifically, a first number of samples is generated by a target ML model based on samples selected from a set of samples. A sample includes a question-answer pair. The set of samples is updated by adding at least a portion of the first number of samples to the set of samples. The target ML model is trained with at least a portion of the updated set of samples. In this way, the self-generalization ability of the ML model is unlocked to perform alignment with near-zero human supervision.

Reference is now made to FIG. 2, which illustrates an example architecture 200 for ML model alignment according to some embodiments of the present disclosure. The architecture 200 involves the ML model 110 and a datastore 220. Seed samples 202 may include a few seed examples (e.g., less than 100) from a target domain. The seed samples 202 may be stored in the datastore 220.

At beginning, the seed samples 202 are the only input to the ML model 110 after SFT. The ML model 110 may generate new samples 204 based on the seed samples 202. The new samples 204 may be filtered before storing into the datastore 220. Then, some samples may be retrieved from the datastore 220 and provided to the ML model 110 after SFT. The sample generating and model training may be performed iteratively. In this way, the ML model 110 is fine-tuned on self-generated samples (from retrieval-augmented ICL) and the aligned ML model 110 is used to generate new samples for further aligning itself.

Retrieval-augmented generation (RAG) represents a hybrid approach that integrates an information retrieval component with a text generation model, specifically tailored for knowledge-intensive tasks. This method's notable advantage lies in its ability to efficiently update its internal knowledge base without the necessity of retraining the entire model. An example of this approach is the k-nearest-neighbor (kNN)-augmented Transformer, which extends the attention context size by incorporating kNN lookups to retrieve context embeddings from similar past instances. Research has indicated that the collection of diverse instruction datasets, coupled with the retrieval of examples most closely matching the input queries, can significantly expedite the model's generalization capabilities.

One key design is to first retrieve relevant and high-quality prompt-output pairs related to the target domain and use them as ICL samples to generate more relevant samples belonging to the target domain. Then, the self-generated samples may be used to finetune the ML model iteratively.

In other words, the architecture 200 may employ retrieval-augmented ICL to enhance the sample generation quality. The architecture 200 is not just iterative but also operates independently of both handcrafted principles and learned reward models, marking a unique advancement in self-alignment methodologies.

Note that the terms “sample” and “example” may be used interchangeably to refer to a prompt-output pair. The prompt-output pairs and question-answer pairs may also be used interchangeably.

Another key design is its iterative mechanism, containing multiple training cycles. Each training cycle leverages the most recent ML model to generate a dataset of more refined quality. This is logical given once ending up with a more aligned model after the alignment, which can generate more high-quality data that in return can be used to further align the ML model until the limit imposed by the model capacity and data quality is reached.

The architecture 200 may work on small models because retrieved samples rather than human instructions are relied on. Thanks to this design, the model only needs to imitate the style of the samples and does not need to understand the abstract concept of safety, truthfulness, or helpfulness from human-crafted principles, which would require a stronger ability that is only shown in large models. The architecture 200 can be adaptable to small models (e.g., as small as 350M) and can be applied across various domains without the need for redesigning principles or retraining reward models.

To better understand the embodiments of the present disclosure, some preliminaries are first described.

Denote the input token space by x and the output token space by y. A sequence of tokens is represented by z=(z₁, . . . , z [symbol] ) for any z₁, . . . , z [symbol] ∈x or y. The notation z_{i,j}=(zᵢ, . . . , zⱼ) is used for any 1<=i<=j<= [symbol] , and z_{i,j}=Ø is defined for any j<i.

A ML model generates an output sequence y=(y₁, y₂, . . . , y_{T}) in response to a given prompt x=(x₁, x₂, . . . , xₙ). The ML model is an auto-regressive model characterized by a conditional probability distribution parameterized by θ as

$${ℙ}_{θ} ( y \vert x ) = {\prod }_{t = 1}^{T} {ℙ}_{θ} ( {y}_{t} \vert x , {y}_{1 : t - 1} ) . \qquad ( 1 )$$

For ICL, it is assumed that there are C samples (x̅¹, y̅¹), . . . , (x̅^{C}, y̅^{C}) curated by humans or retrieved from an external datastore. Those samples serve as context and are combined with the given question to form the prompt. The generation can be characterized by

$${ℙ}_{θ} ( y \vert {\overline{x}}^{1} , {\overline{y}}^{1} , … , {\overline{x}}^{C} , {\overline{y}}^{C} , x ) = {\prod }_{t = 1}^{T} {ℙ}_{θ} ( {y}_{t} \vert {\overline{x}}^{1} , {\overline{y}}^{1} , … , {\overline{x}}^{C} , {\overline{y}}^{C} , x , {y}_{1 : t - 1} ) . \qquad ( 2 )$$

Let [symbol] (x, y)= [symbol] (x)· [symbol] (y|x) be the data distribution. A given dataset [symbol] is included of samples from this distribution:

$$𝒟 = {\{ ( {x}^{i} , {y}^{i} ) \}}_{i = 1}^{N} , \qquad ( 3 )$$

$$where$$

$${x}^{i} ∼ ℙ ( x )$$

$$and$$

$${y}^{i} ∼ ℙ ( y \vert {x}^{i} ) .$$

Given such a dataset, SFT can be conducted using the following cross-entropy loss:

$$ℒ ( θ , 𝒟 ) = - \frac{1}{N} {\sum }_{i = 1}^{N} {\sum }_{t = 1}^{T} log {ℙ}_{θ} ( {y}_{t}^{i} \vert {x}^{i} , {y}_{1 : t - 1}^{i} ) . \qquad ( 4 )$$

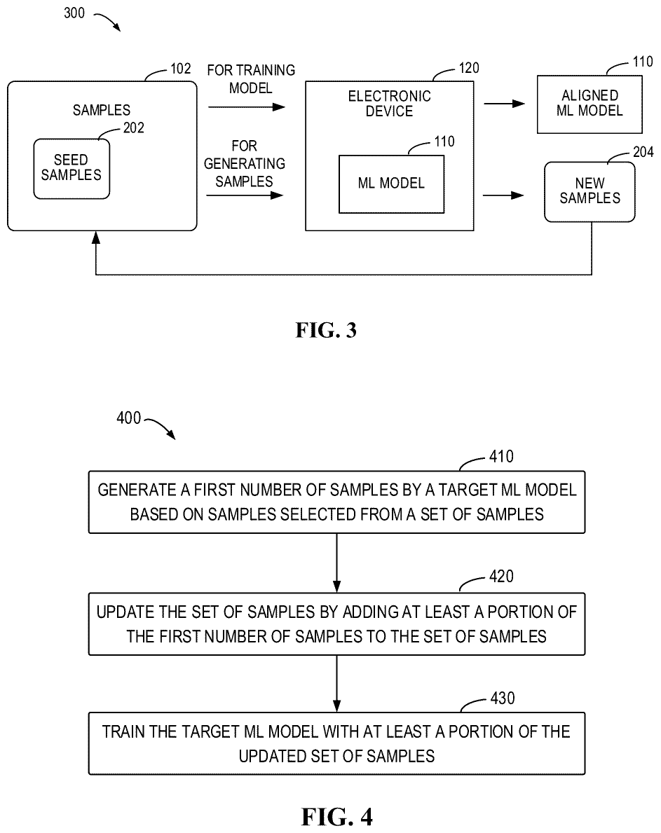

The above has described the architecture 200 for ML model alignment and the preliminaries. The following will introduce a further example architecture with reference to FIG. 3.

FIG. 3 illustrates a schematic diagram of an example architecture 300 for ML model alignment according to some embodiments of the present disclosure. The architecture 300 involves the electronic device 120 and the ML model 110 (also referred to as target ML model). The seed samples 202 may also be referred to as original samples. The set of samples 102 includes the seed samples 202 and the new samples 204 generated by using the ML model 205.

As shown in FIG. 3, the electronic device 120 selects samples from the set of samples 102. A sample includes a question-answer pair. The electronic device 120 generates N samples (also referred to as a first number of samples) by the ML model 205 based on the samples selected. In such cases, the new samples 204 include the N samples. During the sample generation, the electronic device 120 may generate a question-answer pair at a time or generate a question and a corresponding answer respectively.

In some embodiments, the electronic device 120 may select some samples and generate N sample questions by the ML model 110. Then the electronic device 120 may generate a sample answer corresponding to each of N sample questions by the ML model 110. The electronic device 120 may determine N samples based on N sample questions and the corresponding N sample answers. In this way, the electronic device 120 may generate the sample questions and the sample answers respectively.

In some embodiments, for a sample question of N sample questions, the electronic device 120 may determine a plurality of reference questions from the set of samples 102 based on the respective similarities between the sample question and questions in the set of samples 102. Then, the electronic device 120 may generate, by the ML model 110, the sample answer corresponding to the sample question based on the plurality of reference questions and answers corresponding to the plurality of reference questions. In this way, the electronic device 120 may search the similar questions in the set of samples 102 and generate the sample answer corresponding to the sample question based on the similar questions and their answers.

In some embodiments, the electronic device 110 may select C samples (also referred to as a second number of samples) form the set of samples 102. Then the electronic device 110 may generate a sample question based on C samples by the ML model 110. Such sample question may be considered as one of N sample questions. In this way, the electronic device 110 may generate one sample question at a time by the ML model 110.

In some embodiments, the set of samples 102 may include a plurality of datasets, such as datasets [symbol] ₀, . . . , [symbol] ₖ₋₁. Each dataset includes a plurality of samples in the set of samples 102. The electronic device 110 may select C samples across the plurality of datasets. For example, the electronic device 110 may select at least one sample from each of the datasets [symbol] ₀, . . . , [symbol] ₖ₋₁, thereby ensuring each dataset contributes at least one sample to enhance sample diversity.

Continuing with reference to FIG. 3, the electronic device 120 updates the set of samples 102 by adding at least a portion of N samples to the set of samples 102. The electronic device 120 may add all of N samples to the set of samples 102. In some cases, part of N samples may have lower quality. The electronic device 120 may exclude such part and add the rest of N samples to the set of samples 102.

In some embodiments, the electronic device 120 may filter N samples based on their respective sample qualities. Then the electronic device 120 may update the set of samples 102 by adding filtered N samples to the set of samples 102. In this way, the electronic device 120 may remove low quality samples. The electronic device 120 may evaluate the sample qualities by using any suitable model, which is not limited in the present disclosure.

In some embodiments, for a sample of N samples, the sample quality may indicate a similarity between the sample and the existing samples. Optionally, the sample quality may indicate completeness or a clarity of the sample.

Further, the electronic device 120 selects at least a portion of the updated set of samples 102 and trains the ML model 110 with the selected portion.

The set of samples 102 may include the seed samples 202 and the generated samples. In some cases, the seed samples 202 may be manually annotated or selected by humans. The new samples 204 are generated based on the seed samples 202. Thus, the seed samples would have higher quality than the generated new samples 204. In some embodiments, the electronic device 120 may select at least a portion of the seed samples 202 and select C samples from the generated samples, thereby ensuring the training samples to be as the most high-quality as possible. Then the electronic device 120 may train the ML model 110 based on the selected samples to obtain the well-aligned ML model 110.

In view of the above, in one aspect, the electronic device 120 may select samples for generating new samples by the ML model 110. In another aspect, the electronic device 120 may select samples for training the ML model 110 and then output the aligned ML model 110.

In some embodiments, sample generation, sample updating, and model training may be performed iteratively. For example, as shown in FIG. 2, the architecture 200 may include multiple iterations, each encompassing both dataset generation and fine-tuning phases. In this way, only a few question-answer samples (e.g., denoted by dataset [symbol] ₀) are required, and retrieval-augmented alignment can iteratively enhance the performance of the finetuned model.

By taking LM as an example of the ML model 110, the following will describe a process for training or fine-tuning the LM with self-generated datasets with reference to Table 1.

TABLE 1
Algorithm 1 Iterative Self-Alignment
with Retrieval-Augmented ICL (ISARA)

Input:

| | |
|---|---|
| | θ₀: A pretrained LM to align. |
| | [symbol] ₀ = \overline{{}(xⁱ, yⁱ)}ᵢ₌₁^{N}: the initial dataset from the target domain. |
| | K: the maximum number of iterations. |
| | N: the number of samples to generate in each iteration. |
| | C: the number of examples contained in each context. |
| | γ: the coefficient of the loss with respect to the initial dataset. |
| | α: the stopping threshold. |
| 1: | for k ← 1, 2, . . . , K do |
| 2: | [symbol] ₖ^{raw} ← ∅ |
| 3: | for i ← 1, . . . , N do |
| 4: | /* Generate questions with ICL */ |
| 5: | x̅¹, y̅¹, . . . , x̅^{C}, y̅^{C} ← samples sampled from [symbol] ₀, . . . , [symbol] ₖ₋₁ |
| 6: | xⁱ ← [symbol] _{θ}_{_{k−1}}(x \| x̅¹, y̅¹, . . . , x̅^{C}, y̅^{C}) |
| 7: | /* Generate answers with retrieval-augmented ICL */ |
| 8: | \tilde{x}¹, \tilde{y}¹, . . . , \tilde{x}^{C}, |
| | \tilde{y}^{C} ← samples retrieved from [symbol] ₀ , . . . , [symbol] ₖ₋₁ based |

on similarity with xⁱ

| | |
|---|---|
| 9: | yⁱ ← [symbol] _{θ}_{_{k−1}}(\tilde{y} \| |
| | \tilde{x}¹, \tilde{y}¹, . . . , \tilde{x}^{C}, \tilde{y}^{C}, xⁱ) |
| 10: | [symbol] ₖ^{raw} ← [symbol] ₖ^{raw} ∪ {(xⁱ, yⁱ)} |
| 11: | end for |
| 12: | /* Filter the generated dataset */ |
| 13: | [symbol] ₖ ← filter( [symbol] ₖ^{raw} \| [symbol] 0, . . . , [symbol] ₖ₋₁) |
| 14: | /* SFT with the filtered dataset and the initial dataset */ |
| 15: | θₖ ← min_{θ} [symbol] (θ, [symbol] ₖ) + γ [symbol] (θ, [symbol] ₀) |
| 16: | /* Check the stopping condition */ |
| 17: | if \| [symbol] ₖ\| < N · α then |
| 18: | break |
| 19: | end if |
| 20: | end for |

Output: LM θₖ aligned in the target domain.

The LM is represented as θ₀. After model alignment, the aligned LM represented as θₖ is expected to obtain. The initial dataset is represented as [symbol] ₀={(xⁱ, yⁱ)}ᵢ₌₁^{N}, which are manually annotated and indicate the initial dataset from the target domain. xⁱ may represent i-th sample question. yⁱ may represent i-th sample answer. They are generated during a two-steps process (i.e., question generation and answer generation) and are formed into one QA sample.

In the k-th iteration, the goal is to prompt the LM to generate a dataset of N new QA samples. The raw dataset [symbol] ₖ^{raw} is set empty (line 2 of Algorithm 1). This process begins by sampling C QA pairs from all preceding datasets [symbol] ₀, . . . , [symbol] ₖ₋₁, ensuring each dataset contributes at least one example to enhance diversity. QA pairs are sampled from all preceding datasets and are used as contexts to prompt the LM to generate one new question at a time (line 5-6).

Next, retrieval-augmented in-context learning is adopted to annotate the newly generated sample question with a corresponding aligned sample answer (line 8-10). For example, kNN is utilized to identify similar sample questions from preceding datasets based on sentence embeddings. In some examples, external embedding models, such as text-embedding-ada-002, may be used. Both sample questions and sample answers from these pairs are used as contexts in answer generation. Then, the generated QA pairs are added to the dataset [symbol] ₖ^{raw} for updating.

In view of the above, for the i-th iteration, C samples are selected first to generate a sample question. Next, a sample answer corresponding to the sample question is generated. The sample question and sample answer are added to the dataset in the k-th iteration.

Upon generating a set of C new QA pairs, simple filtering criteria may be applied to remove low quality samples, such as excluding QA pairs where the sample question already exists in previous datasets (line 13). Then the filtered dataset [symbol] ₖ is obtained.

Since the context for the LM is always a combination of samples without any human-designed principles, the LM is not required to have the ability to follow human instructions and human efforts are reduced to a new minimum.

After obtaining the dataset [symbol] ₖ, SFT is performed (line 15). This SFT incorporates both the newly generated dataset [symbol] ₖ and the initial dataset [symbol] ₀. The design is to ensure the alignment training data to be as the most high-quality as one can get. Since the initial dataset [symbol] ₀ is manually annotated or selected by humans, it should have high quality. In addition, as the LM aligns iteratively, the latest LM would be the most aligned, and therefore the samples generated by it should have the best quality among all self-generated samples, except the initial samples.

Further, a coefficient γ∈(0, ∞) is employed to regulate the proportion of samples used from each dataset during the fine-tuning process. For example, the cross-entropy loss defined in equation (4) may be used as the SFT loss function.

In some embodiments, sample generation, sample updating, and model training may be performed iteratively until a predetermined stopping condition is met. For example, it is acknowledged empirically that retrieval-augmented alignment may iteratively enhance the performance of the finetuned model. Therefore, the sample generation and finetuning phases are repeated iteratively until a threshold is reached.

In some embodiments, the predetermined stopping condition may include that the maximum number of iterations is reached. Alternatively, and additionally, the predetermined stopping condition may include that the portion of the first number of samples used to update the set of samples includes samples less than a threshold number.

As an example, when less than α∈[0, 1] of newly generated samples remain post-filtering (line 16-18). This ratio may be referred to as the stopping threshold. This stopping threshold indicates the model's peak capability in producing high-quality new QA pairs based on the current samples. As a further example, if the stopping threshold is not provided by users, the iterative training process may be still stopped by setting a maximum number of iterations (e.g., K). In Algorithm 1, both of those stopping conditions are predetermined and output the finetuned model θₖ in the latest iteration before stopping.

Last but not least, the present disclosure aims to align ML models to a new domain with limited samples (e.g. <100). The present disclosure can self-align ML models iteratively without active human involvement. Unlike existing solutions, the present disclosure relies on neither human-crafted instructions nor labeled rewards, significantly reducing human involvement. In addition, the present disclosure can self-improve the alignment continuously. The key idea is to first retrieve high-quality samples related to the target domain and use them as In-context Learning examples to generate more samples. Then the self-generated samples are used to finetune the ML models iteratively. In this way, the model's self-generalization ability is unlocked to perform alignment with near-zero human supervision. After testing on three benchmarks in safety, truthfulness, and instruction-following, the present disclosure shows good performance in alignment, domain adaptability, and scalability.

FIG. 4 illustrates a flowchart of a method 400 of ML model alignment in accordance with some example implementations of the present disclosure. The method 400 may be implemented at the electronic device 120 as illustrated in FIG. 1.

At block 410, the electronic device 120 generates a first number of samples by a target ML model based on samples selected from a set of samples. A sample includes a question-answer pair. At block 420, the electronic device 120 updates the set of samples by adding at least a portion of the first number of samples to the set of samples. At a block 430, the electronic device 120 trains the target ML model with at least a portion of the updated set of samples.

In some embodiments, generating the first number of samples by the target ML model based on the samples selected from the set of samples includes: generating, by the target ML model, the first number of sample questions based on the selected samples; generating, by the target ML model, a sample answer corresponding to each of the first number of sample questions; and determining the first number of samples based on the first number of sample questions and sample answers corresponding to the first number of sample questions.

In some embodiments, generating the sample answer corresponding to each of the first number of sample questions includes: for a sample question of the first number of sample questions, determining a plurality of reference questions from the set of samples based on respective similarities between the sample question and questions in the set of samples; and generating, by the target ML model, the sample answer corresponding to the sample question based on the plurality of reference questions and answers corresponding to the plurality of reference questions.

In some embodiments, generating the first number of samples by the target ML model based on the selected samples includes: selecting a second number of samples from the set of samples; and generating, by the target ML model, a sample question based on the second number of samples as one of the first number of sample questions.

In some embodiments, the set of samples includes a plurality of datasets with each dataset including a plurality of samples in the set of samples, and the second number of samples includes at least one sample from each of the plurality of datasets.

In some embodiments, updating the set of samples by adding at least a portion of the second number of samples to the set of samples includes: filtering the first number of samples based on respective sample qualities of the first number of samples; and updating the set of samples by adding the filtered second number of samples to the set of samples.

In some embodiments, the set of samples includes a plurality of original samples from which other samples in the set of samples are generated, and the at least a portion of the updated set of samples includes the plurality of original samples and the second number of samples.

In some embodiments, the generating a first number of samples, the updating the target ML model, and the training the target ML model with at least a portion of the updated set of samples are performed iteratively until a predetermined stopping condition is met.

In some embodiments, the predetermined stopping condition includes at least one of: the maximum number of iterations is reached, or the portion of the first number of samples used to update the set of samples includes samples less than a threshold number.

In some embodiments of the present disclosure, there is provided a non-transitory computer program product, the non-transitory computer program product including a computer readable storage medium having program instructions embodied therewith, the program instructions executable by an electronic device to cause the electronic device to perform a method of ML model alignment. The method includes generating a first number of samples by a target ML model based on samples selected from a set of samples, a sample including a question-answer pair; updating the set of samples by adding at least a portion of the first number of samples to the set of samples; and training the target ML model with at least a portion of the updated set of samples.

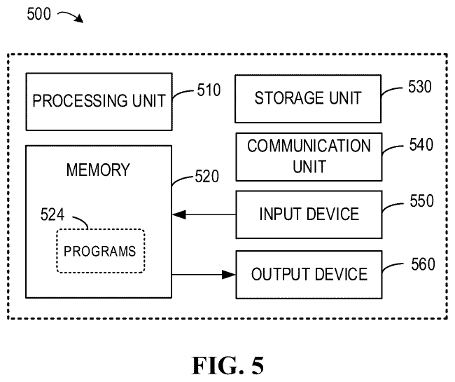

FIG. 5 illustrates a block diagram of an electronic device 500 in which various embodiments of the present disclosure can be implemented. It would be appreciated that the electronic device 500 shown in FIG. 5 is merely for purpose of illustration, without suggesting any limitation to the functions and scopes of the present disclosure in any manner. The electronic device 500 may be used to implement the above method 400. As shown in FIG. 5, the electronic device 500 may be a general-purpose electronic device. The electronic device 500 may at least include one or more processors or processing units 510, a memory 520, a storage unit 530, one or more communication units 540, one or more input devices 550, and one or more output devices 560.

The processing unit 510 may be a physical or virtual processor and can implement various processes based on programs 525 stored in the memory 520. In a multi-processor system, multiple processing units execute computer executable instructions in parallel so as to improve the parallel processing capability of the electronic device 500. The processing unit 510 may also be referred to as a central processing unit (CPU), a microprocessor, a controller, or a microcontroller.

The electronic device 500 typically includes various computer storage medium. Such medium can be any medium accessible by the electronic device 500, including, but not limited to, volatile and non-volatile medium, or detachable and non-detachable medium. The memory 520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 530 may be any detachable or non-detachable medium and may include a machine-readable medium such as a memory, flash memory drive, magnetic disk, or other media, which can be used for storing information and/or data and can be accessed in the electronic device 500.

The electronic device 500 may further include additional detachable/non-detachable, volatile/non-volatile memory medium. Although not shown in FIG. 5, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 540 communicates with a further electronic device via the communication medium. In addition, the functions of the components in the electronic device 500 can be implemented by a single computing cluster or multiple computing machines that can communicate via communication connections. Therefore, the electronic device 500 can operate in a networked environment using a logical connection with one or more other servers, networked personal computers (PCs) or further general network nodes.

The input device 550 may be one or more of a variety of input devices, such as a mouse, keyboard, tracking ball, voice-input device, and the like. The output device 560 may be one or more of a variety of output devices, such as a display, loudspeaker, printer, and the like. By means of the communication unit 540, the electronic device 500 can further communicate with one or more external devices (not shown) such as the storage devices and display device, with one or more devices enabling the user to interact with the electronic device 500, or any devices (such as a network card, a modem, and the like) enabling the electronic device 500 to communicate with one or more other electronic devices, if required. Such communication can be performed via input/output (I/O) interfaces (not shown).

In some embodiments, instead of being integrated in a single device, some, or all components of the electronic device 500 may also be arranged in cloud computing architecture. In a cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single implementation. Rather, various features described in a single implementation may also be implemented in multiple embodiments separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific embodiments of the presently disclosed technology have been described herein for purposes of illustration, but that various modifications may be made without deviating from the scope of the disclosure. Accordingly, the presently disclosed technology is not limited except as by the appended claims.

Embodiments of the subject matter and the functional operations described in the present disclosure can be implemented in various systems, digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular embodiments of particular disclosures. Certain features that are described in the present disclosure in the context of separate embodiments can also be implemented in combination in a single implementation. Conversely, various features that are described in the context of a single implementation can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments. Only a few embodiments and examples are described, and other embodiments, enhancements and variations can be made based on what is described and illustrated in the present disclosure.

What is claimed is:

1. A method of machine learning (ML) model alignment, comprising:
generating a first number of samples by a target ML model based on samples selected from a set of samples, a sample comprising a question-answer pair;
updating the set of samples by adding at least a portion of the first number of samples to the set of samples; and
training the target ML model with at least a portion of the updated set of samples.

2. The method of claim 1, wherein generating the first number of samples by the target ML model based on the samples selected from the set of samples comprises:
generating, by the target ML model, the first number of sample questions based on the selected samples;
generating, by the target ML model, a sample answer corresponding to each of the first number of sample questions; and
determining the first number of samples based on the first number of sample questions and sample answers corresponding to the first number of sample questions.

3. The method of claim 2, wherein generating the sample answer corresponding to each of the first number of sample questions comprises:
for a sample question of the first number of sample questions,
determining a plurality of reference questions from the set of samples based on respective similarities between the sample question and questions in the set of samples; and
generating, by the target ML model, the sample answer corresponding to the sample question based on the plurality of reference questions and answers corresponding to the plurality of reference questions.

4. The method of claim 2, wherein generating the first number of samples by the target ML model based on the selected samples comprises:
selecting a second number of samples from the set of samples; and
generating, by the target ML model, a sample question based on the second number of samples as one of the first number of sample questions.

5. The method of claim 4, wherein the set of samples comprises a plurality of datasets with each dataset comprising a plurality of samples in the set of samples, and
the second number of samples comprise at least one sample from each of the plurality of datasets.

6. The method of claim 1, wherein updating the set of samples by adding at least a portion of the second number of samples to the set of samples comprises:
filtering the first number of samples based on respective sample qualities of the first number of samples; and
updating the set of samples by adding the filtered second number of samples to the set of samples.

7. The method of claim 1, wherein the set of samples comprises a plurality of original samples from which other samples in the set of samples are generated, and the at least a portion of the updated set of samples comprises the plurality of original samples and the second number of samples.

8. The method of claim 1, wherein the generating a first number of samples, the updating the target ML model, and the training the target ML model with at least a portion of the updated set of samples are performed iteratively until a predetermined stopping condition is met.

9. The method of claim 8, wherein the predetermined stopping condition comprises at least one of:
the maximum number of iterations is reached, or
the portion of the first number of samples used to update the set of samples comprises samples less than a threshold number.

10. An electronic device, comprising a computer processor coupled to a computer-readable memory unit, the memory unit comprising instructions that when executed by the computer processor implements acts of ML model alignment, the acts comprising:
generating a first number of samples by a target ML model based on samples selected from a set of samples, a sample comprising a question-answer pair;
updating the set of samples by adding at least a portion of the first number of samples to the set of samples; and
training the target ML model with at least a portion of the updated set of samples.

11. The device of claim 10, wherein generating the first number of samples by the target ML model based on the samples selected from the set of samples comprises:
generating, by the target ML model, the first number of sample questions based on the selected samples;
generating, by the target ML model, a sample answer corresponding to each of the first number of sample questions; and
determining the first number of samples based on the first number of sample questions and sample answers corresponding to the first number of sample questions.

12. The device of claim 11, wherein generating the sample answer corresponding to each of the first number of sample questions comprises:
for a sample question of the first number of sample questions,
determining a plurality of reference questions from the set of samples based on respective similarities between the sample question and questions in the set of samples; and
generating, by the target ML model, the sample answer corresponding to the sample question based on the plurality of reference questions and answers corresponding to the plurality of reference questions.

13. The device of claim 11, wherein generating the first number of samples by the target ML model based on the selected samples comprises:
selecting a second number of samples from the set of samples; and
generating, by the target ML model, a sample question based on the second number of samples as one of the first number of sample questions.

14. The device of claim 13, wherein the set of samples comprises a plurality of datasets with each dataset comprising a plurality of samples in the set of samples, and
the second number of samples comprise at least one sample from each of the plurality of datasets.

15. The device of claim 10, wherein updating the set of samples by adding at least a portion of the second number of samples to the set of samples comprises:
filtering the first number of samples based on respective sample qualities of the first number of samples; and
updating the set of samples by adding the filtered second number of samples to the set of samples.

16. The device of claim 10, wherein the set of samples comprises a plurality of original samples from which other samples in the set of samples are generated, and the at least a portion of the updated set of samples comprises the plurality of original samples and the second number of samples.

17. The device of claim 10, wherein the generating a first number of samples, the updating the target ML model, and the training the target ML model with at least a portion of the updated set of samples are performed iteratively until a predetermined stopping condition is met.

18. The device of claim 17, wherein the predetermined stopping condition comprises at least one of:
the maximum number of iterations is reached, or
the portion of the first number of samples used to update the set of samples comprises samples less than a threshold number.

19. A computer program product, the computer program product comprising a non-transitory computer readable storage medium having program instructions embodied therewith, the program instructions executable by an electronic device to cause the electronic device to perform acts of ML model alignment, the acts comprising:
generating a first number of samples by a target ML model based on samples selected from a set of samples, a sample comprising a question-answer pair;
updating the set of samples by adding at least a portion of the first number of samples to the set of samples; and
training the target ML model with at least a portion of the updated set of samples.

20. The computer program product of claim 19,
wherein generating the first number of samples by the target ML model based on the samples selected from the set of samples comprises:
generating, by the target ML model, the first number of sample questions based on the selected samples;
generating, by the target ML model, a sample answer corresponding to each of the first number of sample questions; and
determining the first number of samples based on the first number of sample questions and sample answers corresponding to the first number of sample questions.
